(19) United States
(12) Patent Application Publication
(10) Pub. No.: US 2015/0057977 A1
(43) Pub. Date: Feb. 26, 2015

(54) OPTICAL MEASURING APPARATUS AND OPTICAL MEASURING METHOD

(71) Applicants: YOKOGAWA ELECTRIC CORPORATION, Tokyo (JP); YOKOGAWA METERS & INSTRUMENTS CORPORATION, Tokyo (JP)

(72) Inventor: Gentaro ISHIHARA, Tachikawa-shi (JP)

(73) Assignees: YOKOGAWA METERS & INSTRUMENTS CORPORATION, Tokyo (JP); YOKOGAWA ELECTRIC CORPORATION, Tokyo (JP)

(21) Appl. No.: 14/462,798

(22) Filed: Aug. 19, 2014

(30) Foreign Application Priority Data
Aug. 26, 2013 (JP) 2013-174705

(51) Int. Cl. G01J 3/28

(52) U.S. Cl. CPC G01J 3/28; G01J 2003/283
USPC 702/189

(57) ABSTRACT

An optical measuring apparatus includes a measuring device configured to measure, by a shot unit, data in a predetermined wavelength range, a controller configured to analyze the measured data, a storage storing the measured data of a plurality of shots and the analysis results of the measured data, and a display configured to display the analysis results and waveform data based on the measured data on a single display screen.

### BACKGROUND OF THE INVENTION

1. Field of the Invention

The present invention relates to an optical measuring apparatus and an optical measuring method, in particular, relates to an improvement of a measurement data logging.

Priority is claimed on Japanese Patent Application No. 2013-174705, filed Aug. 26, 2013, the contents of which are incorporated herein by reference.

2. Description of Related Art

Optical measuring apparatuses include an optical spectrum measuring apparatus such as an optical spectrum analyzer measuring spectrum information of measured target light and an optical wavelength meter, and an optical time domain reflectometer (OTDR) measuring loss distribution information in a longitudinal direction of a fiber to be measured, and the like. These optical measuring apparatuses have functions of analyzing measured waveform data and of obtaining various analyzed data.

For example, some optical spectrum measuring apparatuses include functions of analyzing optical spectrum data obtained by measuring the spectrum of optical communication signal light and of obtaining analyzed data such as the wavelength having maximum power, the power value thereof, and the signal-to-noise ratio (S/N ratio).

For example, some optical time domain reflectometers include, when a loss distribution in a longitudinal direction of an optical communication fiber is measured, functions of analyzing the obtained loss distribution information and of obtaining analyzed data such as the distance to the connection point of the optical fiber, the connection loss, and the amount of reflection at the connection point.

Additionally, for example, some waveform measuring apparatuses include functions of arbitrarily repeating a waveform measurement and a data analysis multiple times and of performing a logging of the analyzed data each time the waveform measurement and data analysis is repeated, and are configured to analyze the time transition of the analyzed data, the singular point thereof, and the like.

Additionally, when optical communication signal light is measured by the optical spectrum measuring apparatus, a user can detect a time change of S/N ratio data and a singular point by repeating a data analysis such as a spectrum measurement and a S/N ratio analysis and recording the S/N ratio data obtained from each data analysis using a logging function.

FIG. 5 is a block diagram showing a configuration example of an optical spectrum measuring apparatus including a logging function of analyzed data in the related art. Measured target light output from a measured target light source 101 is input into an optical measuring device 102. Hereinafter, optical communication signal light is referred to as measured target light.

The optical measuring device 102 measures light spectrum of the measured target light in a predetermined wavelength range, and imports the measured data as waveform data by a shot unit, namely importing one-shot measured data. This waveform data includes a number of sets of the wavelength and the power value at the wavelength (for example, 50,000 sets). Measuring methods of optical spectrum include, for example, a dispersion spectroscopy method using a monochromator or a polychromator and a Fourier spectroscopy method performing a Fast Fourier Transform with respect to an interference pattern obtained using an interferometer, and both methods can be used. X-axis in the obtained optical spectrum data indicates a wavelength value or an optical frequency value, and Y-axis indicates a power value. The following description is made as X-axis indicating a wavelength, but a case of X-axis indicating an optical frequency is also applicable to the following description.

An operation controller 103 analyzes the optical spectrum data to obtain analyzed data such as a wavelength having a maximum optical power (a peak wavelength), a power value thereof (a peak power), a noise level, and a S/N ratio. The operation controller 103 performs, in addition to these data analysis operations, a setting of measuring conditions, and a display processing operation for displaying analysis results on a display screen in a predetermined display form.

A RAM 104 is, for example, a semiconductor memory used as various data storage in the optical spectrum measuring apparatus. The RAM 104 stores, in addition to various analyzed data obtained by the operation controller 103, measuring conditions data, one-shot measuring data to be analyzed, and display data to be displayed on the display screen.

A display 105 is, for example, a liquid crystal display. The display 105 displays various analyzed data stored in the RAM 104 in a desired display form requested by a user such as a table or graph form.

An operation input 106 includes, in addition to buttons and switches provided on an operation panel of the optical spectrum measuring apparatus, a mouse and a keyboard connected to the outside, and the like. The operation input 106 is used by a user for various operation settings of the optical spectrum measuring apparatus such as a setting of a measurement conditions in accordance with a measurement purpose, a cursor operation displayed on the display 105, and a designation of analyzed data to be displayed.

FIG. 6 is a flowchart showing an operation example of the optical spectrum measuring apparatus configured as FIG. 5. Hereinafter, operations for repeating a measurement of a peak wavelength, a peak power, and a S/N ration of optical communication signal light by a shot unit and for performing a logging of various data analyzed by a shot unit will be described.

First, the operation input 106 is operated to set various parameters required for executing a series of optical spectrum measuring functions. After the setting of the parameters have been completed, the logging of analyzed data starts (step S1). The parameters to be set include a measurement time interval when multiple measurements of an optical spectrum by a shot unit are performed, logging operation parameters such as the total number of measurements, optical spectrum measurement operation parameters such as a wavelength range where an optical spectrum is measured, the wavelength resolution, and the measurement sensitivity, an analysis parameter used for an analysis of optical spectrum data, and display operation parameters regarding such as a selection of the analyzed data to be displayed when various logged analyzed data are displayed in a graph or table form, and a display scale setting of graph.

When the logging of various analyzed data is performed, a series of processes described below (step S3 to step S9) is repeated a number of times equal to the total number of measurements set in step S1 (step S2 and step S10).

Specifically, the optical measuring device 102 imports spectrum data of measurement target light by a shot unit (step S3), the operation controller 103 analyzes the optical spectrum data imported by a shot unit to obtain various analyzed data such as the peak wavelength, the peak power, and the S/N ratio (step S4), the analyzed data is stored in the RAM 104 (step S5), and the analyzed data is displayed on the display 105 in a desired display form (step S6).

The next step in the process is delayed until a measurement start time of a next shot so that the time interval of repeating measurements corresponds to the measurement time interval set in step S1 (step S7). While the next step in the process is delayed until the measurement start time of next shot, a user can operate the cursor using the operation input 106, and change the display condition of the graph and table (step S8). When the cursor operation or the display condition is changed, the display is updated (step S9).

When the time to start a measurement of a next shot is reached, the process returns to step S3, and the spectrum measurement process of measurement target light to the logging process of various analyzed data are performed.

The series of logging processes of various analyzed data described above is repeated by a shot unit a number of times equal to the total number of measurements (step S10), and the logging process of the predetermined analyzed data is completed. After the logging process of analyzed data is completed, in a similar way to steps S8 and S9, a user can change the cursor operation or the display condition and update the display, and check the logging results of analyzed data.

FIG. 7 is a table showing a logging data example obtained by a logging function. The logging data is an internal data stored in the RAM 104, and includes a data number 303, which indicates a sequential serial number (number of executions) in each logging process performed by a shot unit, an elapsed-time from a logging start time to a time where the logging process is performed, analyzed data in each logging process, and the like. The analyzed data shown in FIG. 7 includes a peak wavelength 303, a peak power 304, and a SN ratio 305. As aggregate values of each analyzed data in the logging data, a value for each logging process may be calculated as shown by a reference numeral 306: a maximum data (Max), a minimum data (Min), and the maximum data (Max)−the minimum data (Min).

FIG. 8 is a display screen example displayed on the display 105 during executing the data logging function. In FIG. 8, a graph area 401 is provided to graphically display the logging data near the top of display, a table 402 is provided to display the logging data near the bottom of the display, and a display area 403 of cursor information is provided between the graph area 401 and the table 402. A key display area 404 operated by a user is provided near the right of the display, and predetermined functions executed by the input into the operation input 106 are assigned to the key display area 404.

In the graph area 401, a graph 405, in which plots of the logging data are connected with a straight line, displays a time variation of the analyzed data. A user can detect a variation or singular point of the analyzed data from the graph 405.

Cursors 406a and 407a indicate arbitrary times on X-axis, and cursors 406b and 407b indicate some analyzed data on Y-axis. Using these cursors, the analyzed data at an arbitrary time can be indicated on the graph, and a time of the analyzed data to be displayed on the table 402 can be specified. These cursors may be moved to arbitrary positions by a user operation of the operation input 106.

As described above, using the data logging in, for example, a waveform measuring apparatus, a user can perform a logging of the analyzed data and display the logging data in a graph or table form, and can detect the time variation or singular point of the analyzed data. The data logging function in the related art is effective for the check of the time variation of analyzed data, the detection of the singular point, and the like.

Japanese Unexamined Patent Application, First Publication No. S63-25786 discloses a configuration of a data logging system configured to perform a data analysis by a data logger itself in parallel to a data logging.

### SUMMARY OF THE INVENTION

When a user finds a concerned singular point by the data logging function, there are some cases where a user feels like checking later the waveform data at the time corresponding to the singular point or before and after the time in order to check phenomena occurred at the time or investigate the causes of the singular point.

Since the logging data stored by the data logging function in the related art includes only the analyzed data obtained from the measured waveform data, there are some cases where the waveform data at the time corresponding to the singular point or before and after the time cannot be checked later.

One aspect of the present invention realizes an optical measurement apparatus and an optical measuring method in which not only analyzed data, but also waveform data at an arbitrary time can be checked during or after the performance of data logging.

An optical measuring apparatus according to one aspect of the present invention includes a measuring device configured to measure, by a shot unit, data in a predetermined wavelength range, a controller configured to analyze the measured data, a storage storing the measured data of a plurality of shots and the analysis results of the measured data, and a display configured to display the analysis results and waveform data based on the measured data on a single display screen.

In the optical measuring apparatus described above, the measured data may include spectrum data of measured target light.

In the optical measuring apparatus described above, the analysis results may include at least one of an average wavelength, an average power, a maximum wavelength, a minimum wavelength, a maximum power, a minimum power, a standard deviation of wavelength, and a standard deviation of power of the measured target light.

The optical measuring apparatus described above may further include an input used for settings of the optical measuring apparatus. The controller may be configured to read the measured data out of the storage in accordance with operations input to the input, and to display the measured data on the display.

In the optical measuring apparatus described above, the controller may be configured to display the analysis results and the measured data in a graph or table form on the display in accordance with operations input to the input.

In the optical measuring apparatus described above, the storage may store at least one of measured raw spectrum data, compressed spectrum data of the measured data, and thinned spectrum data of the measured data.

In the optical measuring apparatus described above, the controller may be configured to display on the display a graph showing a time variation of the analysis results and waveform data of the measured data at a time in the graph indicated by the operation input to the input.

In the optical measuring apparatus described above, the controller may be configured to update the analysis results and the waveform data of the measured data displayed on the display in accordance with a display condition input to the input.

An optical measuring method according to one aspect of the present invention includes measuring data in a predetermined wavelength range by a shot unit, analyzing the measured data, storing the measured data of a plurality of shots and the analysis results of the measured data, and displaying the analysis results and waveform data based on the measured data on a single display screen.

In the optical measuring method described above, the measured data may include spectrum data of measured target light.

In the optical measuring method described above, the analysis results may include at least one of an average wavelength, an average power, a maximum wavelength, a minimum wavelength, a maximum power, a minimum power, a standard deviation of wavelength, and a standard deviation of power of the measured target light.

The optical measuring method described above may further include inputting optical measuring parameters. Displaying the analysis results and the waveform data may include reading the stored measured data in accordance with the input parameters and displaying the read measured data.

In the optical measuring method described above, displaying the analysis results and the waveform data may include displaying the analysis results and the measured data in a graph or table form in accordance with the input parameters.

In the optical measuring method described above, the stored measured data may include at least one of measured raw spectrum data, compressed spectrum data of the measured data, and thinned spectrum data of the measured data.

The optical measuring method described above may further include indicating a first position in the analysis results displayed in the graph form, and displaying waveform data of the measured data at a time in the graph indicated by the first position.

The optical measuring method described above may further include inputting a display condition of the analysis results and the waveform data of the measured data displayed on the display screen, and updating the analysis results and the waveform data of the measured data in accordance with the display condition.

According to one aspect of the present invention, not only analyzed data, but also waveform data at an arbitrary time can be checked during or after performance of data logging.

### BRIEF DESCRIPTION OF THE DRAWINGS

FIG. 1 is a block diagram showing an optical measuring apparatus according to one embodiment of the present invention.

FIG. 2 is a flowchart showing an operation example of the optical measuring apparatus of FIG. 1.

FIG. 3 is a table showing a logging data example obtained by a data logging function of the optical measuring apparatus according to the embodiment of the present invention.

FIG. 4 is a display screen example during execution of the data logging function of the optical measuring apparatus according to the embodiment of the present invention.

FIG. 5 is a block diagram showing a configuration example of an optical spectrum measuring apparatus including a data logging function in the related art.

FIG. 6 is a flowchart showing an operation example of the optical spectrum measuring apparatus in the related art configured as FIG. 5.

FIG. 7 is a table showing a logging data example obtained by the data logging function of the optical spectrum measuring apparatus of FIG. 5.

FIG. 8 is a display screen example displayed on a display 105 during executing the data logging function of the optical spectrum measuring apparatus of FIG. 5.

### DETAILED DESCRIPTION OF THE INVENTION

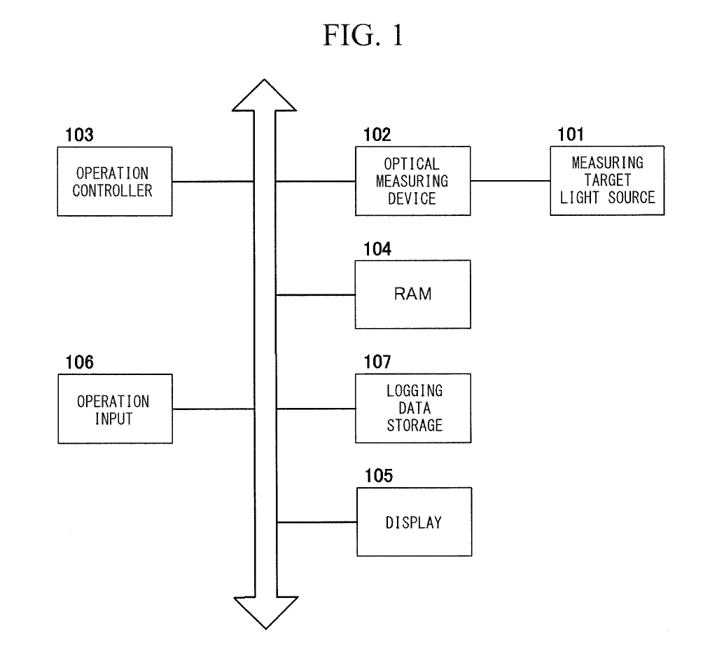

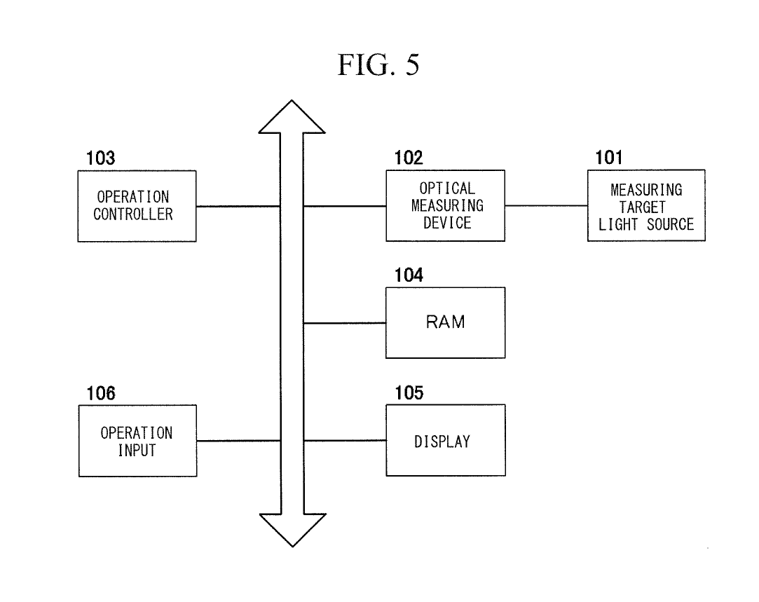

An embodiment of one aspect of the present invention will be described in detail, with references made to the drawings. FIG. 1 is a block diagram showing an optical measuring apparatus according to one embodiment of the present invention, parts that are the same as ones of an optical measuring apparatus in the related art shown in FIG. 5 are assigned the same reference numerals. The difference between FIG. 1 and FIG. 5 is that a logging data storage 107 is provided in FIG. 1. The logging data storage 107 stores measured data of a plurality of shots.

In the configuration shown in FIG. 1, when a user finds a singular point of concern by the data logging function, a user makes a display 105 display waveform data based on the measured data in the corresponding region in order to check the phenomena that occurred at the time corresponding to the singular point or investigate the causes of the singular point.

An operation controller 103 reads out the measured data in the corresponding region from the logging data storage 107 in accordance with an operation input performed by a user using an operation input 106, generates a waveform display of the waveform data at the time corresponding to the singular point or before and after the time, and makes the display 105 display the waveform display.

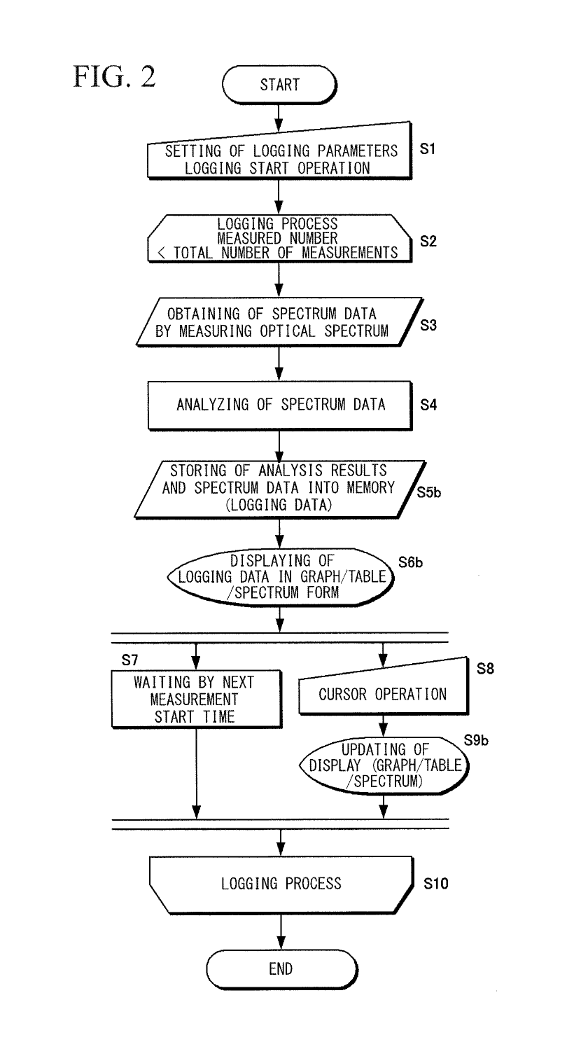

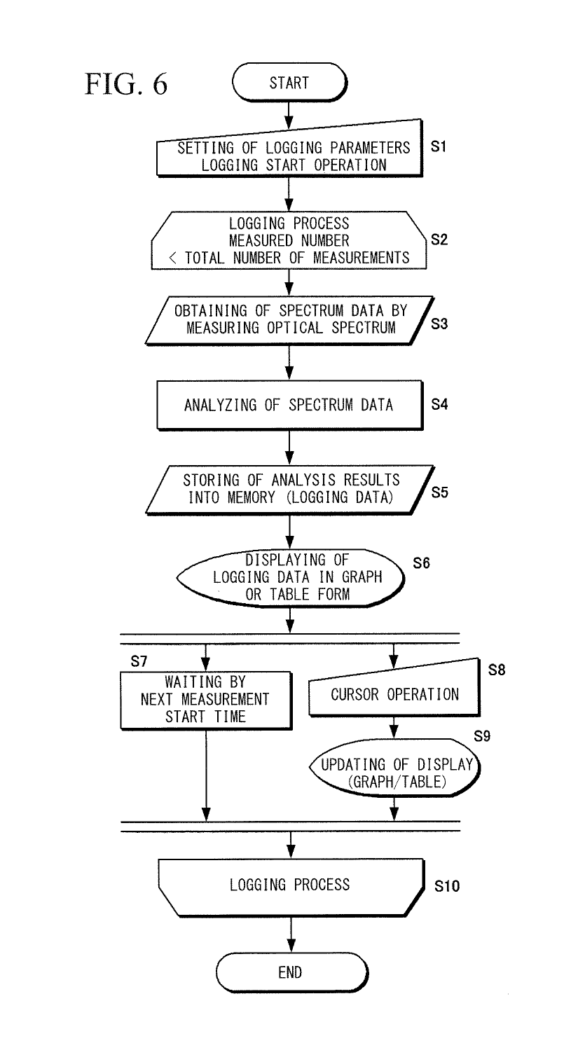

FIG. 2 is a flowchart showing an operation example of the optical spectrum measuring apparatus configured as FIG. 1, steps that are the same as ones of the flowchart shown in FIG. 6 are assigned the same reference numerals. The differences between FIG. 2 and FIG. 6 are steps S5, S6, and S9, and only these differences will mainly be described below.

The logging process of each piece of the analyzed data in the configuration of FIG. 1 is also performed by repeating a series of processes (step S3 to step S9) a number of times equal to the total number of measurements set in step S1 (steps S2 and S10)

In the logging process, an optical measuring device 102 measures spectrum data of measured light (step S3), an operation controller 103 analyzes the spectrum data to obtain analyzed data such as the peak wavelength, the peak power, and the S/N ratio (step S4), and stores both the spectrum data, which is measured data, and the analyzed data into the logging data storage 107 as logging data (step S5b). The difference between step S5b and step S5 in the related art shown in FIG. 6 is that, in step S5b, in addition to storing the analyzed data into the RAM 104, the spectrum data, which is measured data, is also stored into the logging data storage 107 as the logging data.

When the spectrum data, which is measured data, is stored into the logging data storage 107, in consideration of the data storage area size of the logging data storage 107 and the data size of the spectrum data, only raw spectrum data as measured may be stored, only spectrum data compressed or thinned reversibly or irreversibly may be stored, and these both spectrum data may be stored.

An internal memory (RAM) of the optical spectrum measuring apparatus and an external storage, and the like may be separately prepared as the logging data storage 107. For example, the raw spectrum data, which is measured data, may be stored into the external storage, and the compressed spectrum data may be stored into the internal area.

Thereby, the internal area, which has a limit to the data storage capacity, may store the compressed and reduced spectrum data, and the external area, which is easily scalable by connecting a large capacity storage, may store the raw spectrum data, which tends to be large in size.

The analyzed data, which is logging data, and the spectrum data as waveform data is displayed on the display 105 in an appropriate predetermined display form such as a graph or table form (step S6b).

The difference between step S6b and step S6 in the related art shown in FIG. 6 is that, in step S6b, the waveform of spectrum is displayed on the display 10 based on the spectrum data of logging data, which is measured data, stored in the logging data storage 107.

When the waveform of spectrum is displayed, among the spectrum data stored in the logging data storage 107, the raw spectrum data may be displayed, or the compressed or thinned spectrum data may be displayed.

The next step in the process is delayed until a next measurement start time so that the time interval of repeating measurements corresponds to the measurement time interval set in step S1 (step S7). While the next step in the process is delayed until the next measurement start time, a user can operate the cursor using the operation input 106, and change the display condition of the graph and table (step S8). When the cursor operation or the display condition is changed, the display is updated (step S9b).

The difference between step S9b and step S9 in the related art shown in FIG. 6 is that, in step S9b, when the display is updated, not only the graph or table, but also the waveform display of the related spectrum are updated. Thereby, a user can check the of spectrum waveform on the display screen at the time corresponding to the position of the cursor operated in step S8.

When the time to start the next logging is reached, the process returns to step S3, and the logging process starting from the spectrum measurement process of measurement target light is performed.

The series of logging process as described above is repeated a number of times equal to the total number of measurements (step S10), and the logging process is completed. After the logging process is completed, in a similar way to steps S8 and S9, a user can change the cursor operation or the display condition, update the display, and check the logging results.

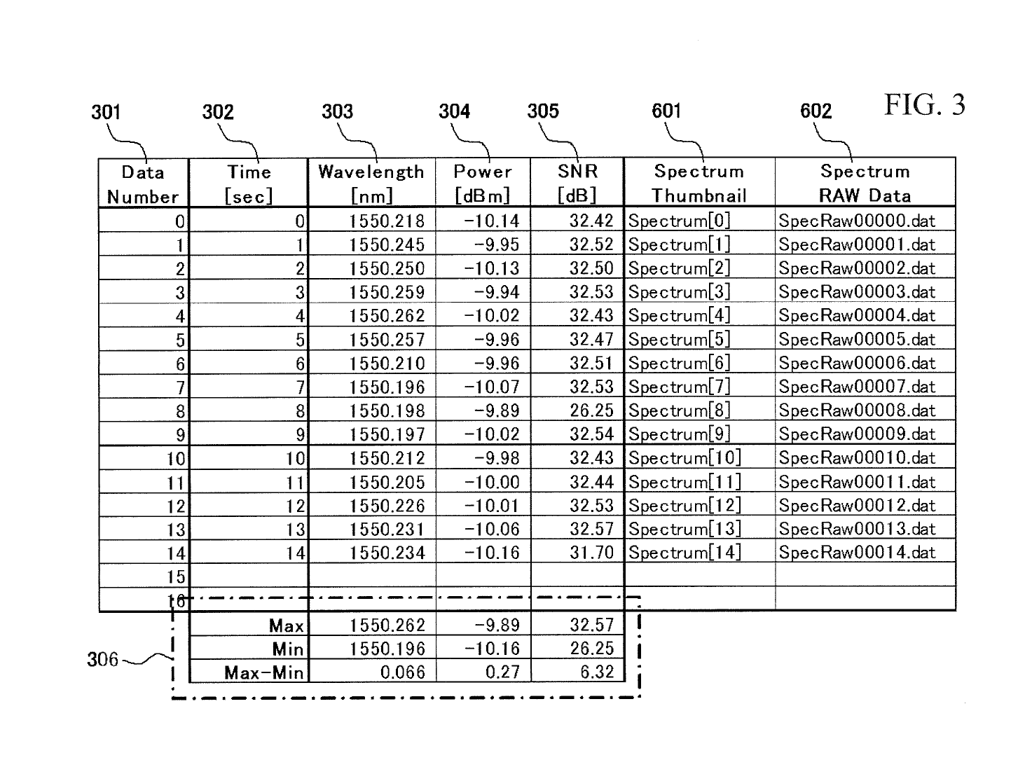

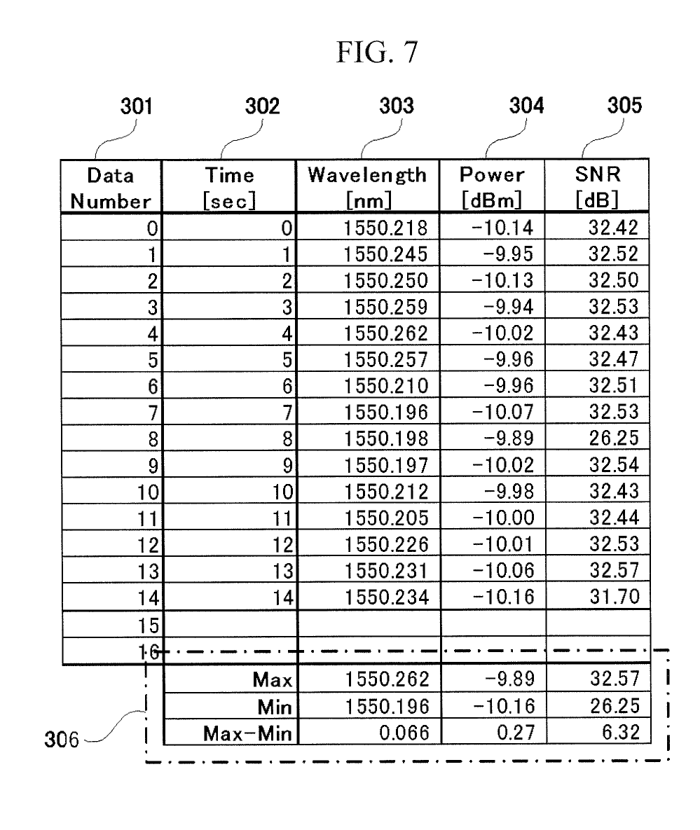

FIG. 3 is a table showing a specific example of logging data according to the embodiment of the present invention. The difference between the logging data table shown in FIG. 3 and the logging data table obtained by the data logging function in the related art shown in FIG. 7 is that the presence or absence of columns of a spectrum thumbnail indicated by a reference numeral 601 and a spectrum raw data indicated by a reference numeral 602. Other columns shown in FIG. 3 are the same as those of FIG. 7.

As described above, the difference between the logging function according to the embodiment of the present invention and the logging function in the related art is that the spectrum data, which is measured data, is also stored in the logging data storage 107 in the logging process. Namely, in comparison with the logging data shown in FIG. 7, the columns of the spectrum thumbnail indicated by the reference numeral 601 and the spectrum raw data indicated by the reference numeral 602 are added to the logging data table shown in FIG. 3.

The spectrum thumbnail of the column indicated by the reference numeral 601 is thinned spectrum data, and, in this example, shows memory address information when the spectrum data is stored in the logging data storage 107. The thinned spectrum data is, for example, stored in the RAM 104.

The spectrum raw data of the column indicated by the reference numeral 602 is spectrum data, which is measured data as it is, and, in this example, shows a data file name when the spectrum raw data is stored in the logging data storage 107. In this example, the raw spectrum data is stored in the logging data storage 107, but the raw spectrum data may be stored in any of the RAM 104 and the logging data storage 107.

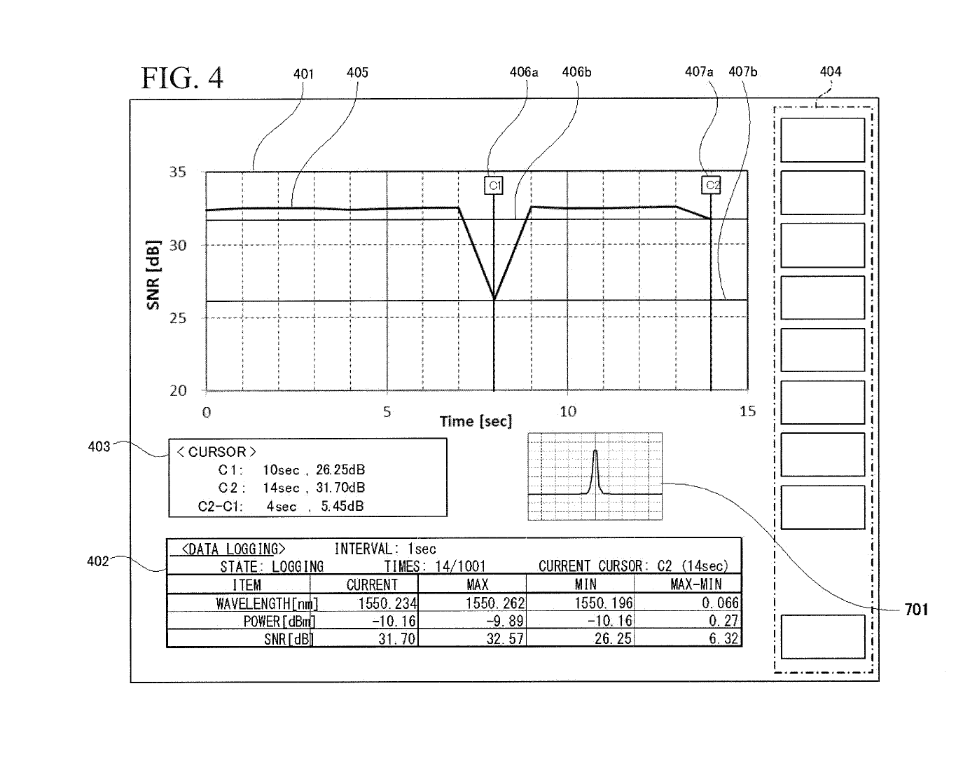

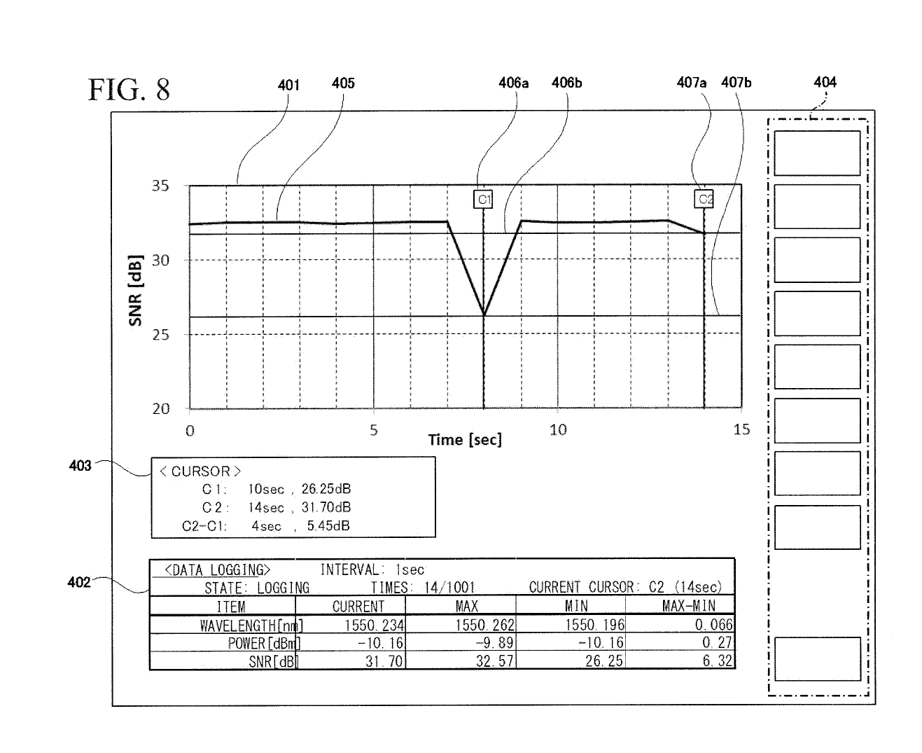

FIG. 4 is a display screen example displayed on the display 105 during execution of the data logging function of the optical measuring apparatus according to the embodiment of the present invention. The difference between the display screen shown in FIG. 4 and the display screen example during execution of the data logging function of the optical measuring apparatus in the related art shown in FIG. 8 is the presence or absence of a waveform data display area 701 based on the measured data. Others elements shown in FIG. 4 are the same as those shown in FIG. 8.

The waveform data display area 701 is a spectrum display area, and displays waveform data of the optical spectrum at the time corresponding to the cursor position using the spectrum data of the measured data, which is logging data at the cursor position.

As described above, since the logging data of the logging function according to the embodiment of the present invention includes, in addition to the analyzed data, the spectrum data, which is measured data, even during or after performance of the data logging, the waveform data of the spectrum data of any data number of the column 301 shown in FIG. 3 can be displayed on the waveform data display area 701 provided on the display screen of the display 105.

Namely, by the logging function according to the embodiment of the present invention, a user can check not only the analyzed data, but also the waveform data at an arbitrary time during or after performance of the data logging.

A spectrum read operation may be performed to read raw spectrum data at a cursor position out of the logging data storage 107 after the logging process and to display the raw spectrum data on the display screen of the display 105.

Thereby, a raw spectrum waveform at an arbitrary time can be checked, and the spectrum can be analyzed by performing various analysis processes using the operation controller 103.

As described above, according to the embodiment of the present invention, the optical measuring apparatus is realized where not only the analyzed data, but also the waveform data at an arbitrary time during or after performance of the data logging can be checked.

What is claimed is:

1. An optical measuring apparatus comprising:
a measuring device configured to measure, by a shot unit, data in a predetermined wavelength range;
a controller configured to analyze the measured data;
a storage storing the measured data of a plurality of shots and the analysis results of the measured data; and
a display configured to display the analysis results and waveform data based on the measured data on a single display screen.

2. The optical measuring apparatus according to claim 1, wherein the measured data includes spectrum data of measured target light.

3. The optical measuring apparatus according to claim 2, wherein the analysis results include at least one of an average wavelength, an average power, a maximum wavelength, a minimum wavelength, a maximum power, a minimum power, a standard deviation of wavelength, and a standard deviation of power of the measured target light.

4. The optical measuring apparatus according to claim 1, further comprising an input used for settings of the optical measuring apparatus,
wherein the controller is configured to read the measured data out of the storage in accordance with operations input to the input, and to display the measured data on the display.

5. The optical measuring apparatus according to claim 4, wherein the controller is configured to display the analysis results and the measured data in a graph or table form on the display in accordance with operations input to the input.

6. The optical measuring apparatus according to claim 1, wherein the storage stores at least one of measured raw spectrum data, compressed spectrum data of the measured data, and thinned spectrum data of the measured data.

7. The optical measuring apparatus according to claim 4, wherein the controller is configured to display on the display a graph showing a time variation of the analysis results and waveform data of the measured data at a time in the graph indicated by the operation input to the input.

8. The optical measuring apparatus according to claim 4, wherein the controller is configured to update the analysis results and the waveform data of the measured data displayed on the display in accordance with a display condition input to the input.

9. An optical measuring method comprising:
measuring data in a predetermined wavelength range by a shot unit;
analyzing the measured data;
storing the measured data of a plurality of shots and the analysis results of the measured data; and
displaying the analysis results and waveform data based on the measured data on a single display screen.

10. The optical measuring method according to claim 9, wherein the measured data includes spectrum data of measured target light.

11. The optical measuring method according to claim 10, wherein the analysis results include at least one of an average wavelength, an average power, a maximum wavelength, a minimum wavelength, a maximum power, a minimum power, a standard deviation of wavelength, and a standard deviation of power of the measured target light.

12. The optical measuring method according to claim 9, further comprising inputting optical measuring parameters,
wherein displaying the analysis results and the waveform data includes reading the stored measured data in accordance with the input parameters and displaying the read measured data.

13. The optical measuring method according to claim 12, wherein displaying the analysis results and the waveform data includes displaying the analysis results and the measured data in a graph or table form in accordance with the input parameters.

14. The optical measuring method according to claim 9, wherein the stored measured data includes at least one of measured raw spectrum data, compressed spectrum data of the measured data, and thinned spectrum data of the measured data.

15. The optical measuring method according to claim 13, further comprising:
indicating a first position in the analysis results displayed in the graph form; and
displaying waveform data of the measured data at a time in the graph indicated by the first position.

16. The optical measuring method according to claim 9, further comprising:
inputting a display condition of the analysis results and the waveform data of the measured data displayed on the display screen; and
updating the analysis results and the waveform data of the measured data in accordance with the display condition.
